(19) United States
(12) Patent Application Publication
(10) Pub. No.: US 2006/0085562 A1
(43) Pub. Date: Apr. 20, 2006

(54) Devices and methods for remote computing using a network processor

(76) Inventor: Bruce Eric Blaho, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/989,666

(22) Filed: Nov. 16, 2004

Related U.S. Application Data
(60) Provisional application No. 60/618,697, filed on Oct. 14, 2004.

(51) Int. Cl. G06F 15/16

(52) U.S. Cl. 709/247

(57) ABSTRACT

In one embodiment, a method comprises receiving, at a network processor unit included in a host device, raster data for a remote computing session executing on a main processor of the host device. The method further comprises compressing the raster data using remote computing software executing on a network processor included in the network processor unit and transmitting the compressed raster data to a client device for display thereby. In another embodiment, a method comprises receiving, at a network processor unit included in a client device, compressed raster data for a remote computing session executing on a host device. The client device comprises a main processor operable to execute first remote computing software operable to affect the remote computing session. The method further comprises decompressing the received compressed raster data using second remote computing software executing on a network processor included in the network processor unit.

### CROSS REFERENCE TO RELATED APPLICATION

This application is related to and claims the benefit under 35 USC 119(e) of Provisional Application Ser. No. 60/618,697 (the '697 Application), filed on Oct. 14, 2004. The '697 Application is incorporated by reference.

### TECHNICAL FIELD

The following description relates to computers in general and to remote computing in particular.

### BACKGROUND

One approach to providing computing services to multiple users involves providing each user with a separate computer on which software used by that user is executed. Such a computer is also referred to as a “personal computer” or a “workstation” and is typically located near the user. Also, each personal computer includes sufficient computing resources to execute the software used by the user of that personal computer.

Another approach to providing computing services to multiple users is to execute at least some of the software used by each user on a remote computer (also referred to as a “server” or “host”). This approach is also referred to here as the “server-based” approach. Each user uses a local computer (or other device) to access the software executing on the server. The local computer and the server typically communicate with one another over a network (for example, a local area network, a wide area network, or a virtual private network (VPN)). In some embodiments, a user, in addition to executing software on a server using such a server-based approach, also executes software locally on the user's local computer.

The local computer typically receives from the user input intended for software executing on the server (for example, via a keyboard or pointing device coupled to the local computer) and communicates the received input to the software executing on the server. The server receives the user input and forwards the user input to the software executing on the server. The software executing on the server typically generates display information that is communicated from the server to the local computer. The local computer uses the display information to render a user interface and application-specific content (collectively referred to here as the “display image”) for the software executing on the server. The local computer displays the display image on a display device (for example, a computer monitor) coupled to the local computer.

The processing that is performed by the server in order to receive and process user input transmitted from a local computer and to generate and transmit the display information to the local computer is also referred to here as “remote computing overhead.” In one common remote computing configuration, all the remote computing overhead functions are carried out by the same processor that is used to execute application software for the user sessions, which can reduce the computing resources that are available for running the application software. Also in such a configuration, the speed with which the remote computing overhead processing is performed is typically limited by the speed and loading of that processor.

In another remote computing configuration, special-purpose hardware is used to perform at least some of the remote computing processing. Thus, the processor on which the application software for the user sessions executes need not perform such remote computing processing. However, the use of such special-purpose hardware typically increases the cost and complexity of implementing such a remote computing configuration. Also, the use of such special-purpose hardware typically imposes various constraints on such a configuration (for example, constraints related to wiring, image resolution, and the number of supported user sessions).

### SUMMARY

In one embodiment, a method comprises receiving, at a network processor unit included in a host device, raster data for a remote computing session executing on a main processor of the host device. The method further comprises compressing the raster data using remote computing software executing on a network processor included in the network processor unit and transmitting the compressed raster data to a client device for display thereby.

In another embodiment, a method comprises receiving, at a network processor unit included in a client device, compressed raster data for a remote computing session executing on a host device. The client device comprises a main processor operable to execute first remote computing software operable to affect the remote computing session. The method further comprises decompressing the received compressed raster data using second remote computing software executing on a network processor included in the network processor unit.

In another embodiment, a host computer comprises first remote computing software adapted to execute on a main processor of the host computer. The first remote computing software is operable to cause the main processor to establish a remote computing session for a client device. A display image comprising raster data is generated for the remote computing session. The host computer further comprises a network interface through which the host computer communicates with the client device. The network interface comprises a network processor adapted to execute second remote computing software. The second remote computing software is operable to cause the network processor to compress at least a portion of the raster data. The network interface transmits the compressed raster data to the client device.

In another embodiment, a client device comprises first remote computing software adapted to execute on a main processor of the client device. The first remote computing software is operable to affect a remote computing session executing on a host computer. The host computer generates a display image comprising raster data for the remote computing session and compresses the raster data. The client device further comprises a network interface through which the client device communicates with the host computer. The network interface comprises a network processor adapted to execute second remote computing software. The second remote computing software is operable to cause the network processor to decompress the compressed raster data when the compressed raster data is received by the network interface from the host computer.

The details of various embodiments of the claimed invention are set forth in the accompanying drawings and the description below. Other features and advantages will become apparent from the description, the drawings, and the claims.

### DRAWINGS

FIG. 1 is a block diagram of one embodiment of a remote computing system.

FIG. 2 is a block diagram of one embodiment of a network processor unit.

FIG. 3 is a flow diagram of one embodiment of a method of processing raster data in a network processor unit.

FIG. 4 is a block diagram of one embodiment of a method of processing raster data in a network processor unit.

Like reference numbers and designations in the various drawings indicate like elements.

### DETAILED DESCRIPTION

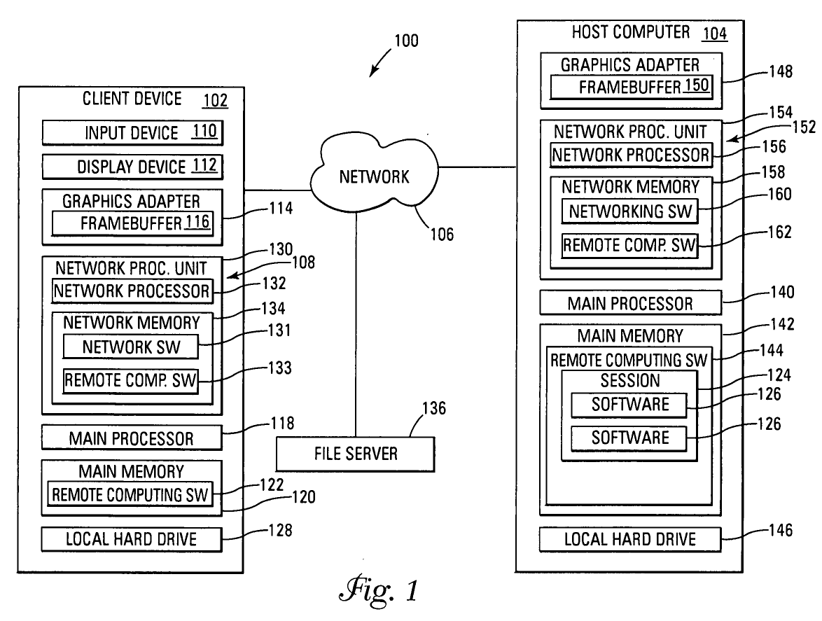

FIG. 1 is a block diagram of one embodiment of a remote computing system 100. A user of a client device 102 accesses a host computer 104 over a network 106. In one embodiment, the network 106 comprises a wide area network such as the Internet. In other embodiments, the network 106 comprises other types of networks such as a local area network (LAN) and/or a virtual private network. The client device 102 comprises a network interface 108 that communicatively couples the client device 102 to the network 106.

In the embodiment shown in FIG. 1, the client device 102 includes at least one input device 110 for receiving input from a user of the client device 102. In one implementation, the input device 110 comprises a keyboard and a pointing device such as a mouse or trackball. The client device 102 also includes at least one display device 112. In one implementation, the display device 112 comprises a computer monitor. The client device 102 also includes a graphics adapter 114 that provides an interface between the display device 112 and the other components of the client device 102. In the embodiment shown in FIG. 1, the graphics adapter 114 further includes a frame buffer 116 in which raster data is stored. The raster data stored in the frame buffer 116 is used by the graphics adapter 114 and software executing on the client device 102 to generate a display image for display on the display device 112.

The client device 102 also includes at least one programmable processor 118 and memory 120 in which software executed by the programmable processor 118 and related data structures are stored during execution. The programmable processor 118 is also referred to here as the “main processor” 118 of the client device 102 and the memory 120 is also referred to here as the “main memory” 120 of the client device 102. Main memory 120 comprises any suitable memory now know or later developed such as, for example, random access memory (RAM), read only memory (ROM), and/or registers within the main processor 118. In one implementation, the main processor 118 comprises a microprocessor. Software executing on the main processor 118 performs at least some of the processing described here as being performed by the client device 102. In the embodiment shown in FIG. 1, the main processor 118 executes remote computing software 122 that communicates with the host computer 104 in order to establish, interact with, and/or otherwise affect a session 124 in which one or more items of software 126 are executed on the host computer 104.

The software (including the remote computing software 122) executed by the main processor 118 of the client device 102 comprises appropriate program instructions that implement the functionality to be performed by the software. The program instructions for such software are stored on or in a computer-readable medium. In the embodiment shown in FIG. 1, the computer-readable medium comprises a local hard drive 128. During operation, the main processor 118 reads the program instructions from the hard disk 128 and executes the program instructions.

In other embodiments, the software that executes on the main processor 118 is stored on different types of computer-readable media such as a flash disk, ROM, or removable media such as a floppy drive or a CD-ROM. In other embodiments, the computer-readable media is not local to the client device 102. For example in one such embodiment, the software that is executed on the client device 102 is stored on a file server 136 that is coupled to the client device 102 over, for example, the network 106. In such an embodiment, the client device 102 retrieves such software from the file server 136 over the network 106 in order to execute the software. In other embodiments, such software is delivered to the client device 102 for execution thereon in other ways. For example, in one such other embodiment, such software is implemented as a servelet (for example, in the JAVA(R) programming language) that is downloaded from a hypertext transfer protocol (HTTP) server and executed by the client device 102 using an Internet browser running on the client device 102.

In the embodiment shown in FIG. 1, the network interface 108 comprises a network processor unit 130. The network processor unit 130 includes a programmable processor 132 and memory 134 in which software executed by the programmable processor 132 and related data structures are stored during execution. The programmable processor 132 is also referred to here as the “network processor” 130 of the client device 102 and the memory 134 is also referred to here as the “network processor memory” 134 of the client device 102.

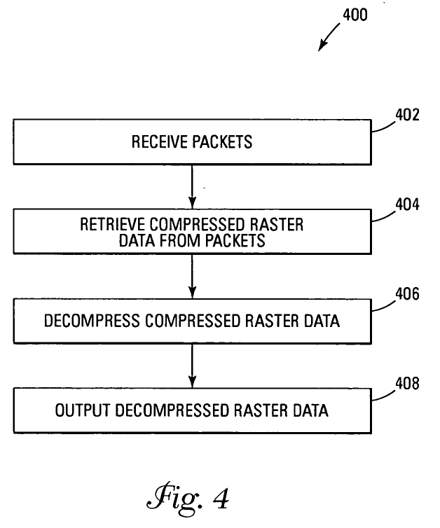

The network processor memory 134 comprises any suitable memory such as, for example, random access memory (RAM), read only memory (ROM), and/or registers within the network processor 132. The software executed by the network processor 132 comprises network software 131 that controls and/or performs networking functions supported by the network interface 108. For example, in one embodiment, the network interface 108 is an ETHERNET network interface that is used to couple the client device 102 to an ETHERNET network and the network software 131 controls and/or performs networking functions to interface to an ETHERNET network. In the embodiment shown in FIG. 1, the software executed by the network processor 132 also comprises remote computing software 133. The remote computing software 133 performs some of the remote computing processing (for example, some of the remote computing overhead processing) that is performed to interact with the session 124 executing on the host computer 104. In one implementation (for example, the embodiment of method 400 shown in FIG. 4), the remote computer software 133 processes raster data received from the host computer 104 for use in generating a display image displayed on the display device 112.

The software (including the network software 131 and the remote computing software 133) executed by the network processor 132 comprises appropriate program instructions that implement the functionality to be performed by the software. The program instructions for such software are stored on or in a computer-readable medium. In one embodiment, the computer-readable medium in which the software executed on the network processor 132 is stored comprises a flash memory device (not shown in FIG. 1). During operation, the network processor 132 reads the program instructions from the flash memory device and executes the program instructions.

In other embodiments, the software executed on the network processor 132 is stored on different types of computer-readable media such as a local hard drive, ROM, or removable media such as a floppy drive or a CD-ROM. In other embodiments, the computer-readable media is not local to the client device 102. For example in one such embodiment, such software is stored on the file server 136.

The various components of the client device 102 are communicatively coupled to one another as needed using appropriate interfaces (for example, using buses, ports, and the like).

In one implementation of the client device 102 shown in FIG. 1, the client device 102 is implemented as a “thin client” that is designed primarily to use and interact with software executing on the host computer 104. In another implementation, the client device 102 is implemented as a “thick client” using a personal computer or workstation that is capable of running various types of software locally in addition to using and interacting with software executing on the host computer 104.

The host computer 104 comprises at least one programmable processor 140 and memory 142 in which software executed by the programmable processor 140 and related data structures are stored during execution. The programmable processor 140 is also referred to here as the “main processor” 140 of the host computer 104 and the memory 142 is also referred to here as the “main memory” 142 of the host computer 104. Main memory 142 comprises any suitable memory such as, for example, random access memory (RAM), read only memory (ROM), and/or registers within the main processor 140. In one implementation, the main processor 140 comprises a microprocessor. Software executing on the main processor 140 performs at least some of the processing described here as being performed by the host computer 104. In the embodiment shown in FIG. 1, the main processor 140 executes remote computing software 144 that, when requested by the client device 102, establishes the session 124, executes the items of software 126 within the session 124, and interacts with client device 102.

The software (including the remote computing software 144) executed by main processor 140 comprises appropriate program instructions that implement the functionality to be performed by the software. The program instructions for such software are stored on or in a computer-readable medium. In the embodiment shown in FIG. 1, the computer-readable medium comprises a local hard drive 146. During operation, the main processor 140 reads the program instructions from the hard disk 146 and executes the program instructions.

In other embodiments, the software that executes on the main processor 140 is stored on different types of computer-readable media such as a flash disk, ROM, or removable media such as a floppy drive or a CD-ROM. In other embodiments, the computer-readable media is not local to the host computer 104. For example in one such embodiment, the software that is executed on the host computer 104 is stored on the file server 136 that is coupled to the host computer 104 over, for example, the network 106.

The host computer 104 further comprises a graphics adapter 148. The graphics adapter 148, under control of software executing on the main processor 140, is used to generate a display image for the session 124 executing on the host computer 104. As described below, at least a portion of the display image is transmitted to the client device 102 for display on the display device 112. Such a display image comprises raster data (that is, data describing each pixel that makes up the display image). In the embodiment shown in FIG. 1, the raster data is stored in a frame buffer 150 included in the graphics adapter 148. The frame buffer 150 comprises memory that stores the raster data for the display image.

The host computer 104 also includes a network interface 152 that is used to couple the host computer 104 to the network 106. In the embodiment shown in FIG. 1, the network interface 152 comprises a network processor unit 154. The network processor unit 154 includes a programmable processor 156 and memory 158 in which software executed by the programmable processor 156 and related data structures are stored during execution. The programmable processor 156 is also referred to here as the “network processor” 156 of the host computer 104 and the memory 158 is also referred to here as the “network processor memory” 158 of the host computer 104.

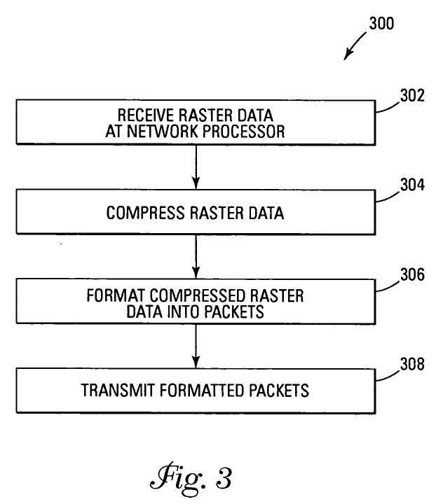

The network processor memory 158 comprises any suitable memory such as, for example, random access memory (RAM), read only memory (ROM), and/or registers within the network processor 156. The software executed by the network processor 156 comprises network software 160 that controls and/or performs networking functions supported by the network interface 152. For example, in one embodiment, the network interface 152 is an ETHERNET network interface that is used to couple the host computer 104 to an ETHERNET network and the network software 160 controls and/or performs networking functions to interface to an ETHERNET network. In the embodiment shown in FIG. 1, the software executed by the network processor 156 also comprises remote computing software 162. As described in more detail below, the remote computing software 162 performs some of the remote computing processing (for example, some of the remote computing overhead processing) for the session 124 and the client device 102 to communicate with one another. In one implementation (for example, the embodiment of method 300 shown in FIG. 3), the remote computer software 162 executing on the network processor 156 retrieves raster data from the frame buffer 150 of the graphics adapter 148, compresses the retrieved raster data, and transmits the compressed raster data to the client device 102 for display on the display device 112.

The software (including the network software 160 and the remote computing software 162) executed by the network processor 156 comprises appropriate program instructions that implement the functionality to be performed by the software. The program instructions for such software are stored on or in a computer-readable medium. In one embodiment, the computer-readable medium in which the software executed on the network processor 156 is stored comprises a flash memory device (not shown in FIG. 1). During operation, the network processor 156 reads the program instructions from the flash memory device and executes the program instructions.

In other embodiments, the software executed on the network processor 156 is stored on different types of computer-readable media such as a local hard drive, ROM, or removable media such as a floppy drive or a CD-ROM. In other embodiments, the computer-readable media is not local to the host computer 104. For example in one such embodiment, such software is stored on the file server 136.

The various components of the host computer 104 are coupled to one another as needed using appropriate interfaces (for example, using buses, ports, and the like).

In one implementation of the embodiment of the host computer 104 shown in FIG. 1, each host computer 104 is packaged in a blade configuration suitable for mounting in a rack.

During operation, a user of the client device 102 accesses the host computer 104 over the network 106 in order to establish the session 124 on the host computer 104 and execute the one or more items of software 126 in the session 124. In one embodiment, the software 126 executed in the session 124 is stored on the file server 136. The host computer 104 retrieves the software 126 stored on the file server over the network 106 when such software 126 is executed in the session 124.

The user provides input to the session 124 and the software 126 by using the input device 110 (for example, using a keyboard and/or a pointing device) to provide input to the client device 104. The remote computer software 122 executing on the main processor 118 of the client device 102 receives, interprets, and, if appropriate, forwards user input to the host computer 104 over the network 106. The remote computer software 144 executing on the main processor 140 of the host computer 104 receives the input and forwards the received input to the session 124 and the software 126, as appropriate, for processing thereby.

The session 124 and the software 126 running in the session 124 generate a display image (for example, containing a user interface and application-specific content) for that session 124. The session display image is generated by the session 124 and the software 126 using the graphics adapter 148. For example, each item of software 126 executing in the session 124 interacts with a device driver compatible with the graphics adapter 148 to generate portions of the session display image associated with that item of software 126. The session display image, in the embodiment shown in FIG. 1, is generated and stored in the frame buffer 150.

At least a portion of the raster data for the session display image is retrieved from the frame buffer 150, compressed, and transmitted to the client device 102 for display on the display device 112. In the embodiment shown in FIG. 1, the remote computing software 162 executing on the network processor 156 of the host computer 104 performs such retrieving, compressing, and transmitting. One embodiment of such processing is described below in connection with the embodiment of method 300 shown in FIG. 3. In the embodiment shown in FIG. 1, the remote computing software 133 executing on the network processor 132 of the client device 102 receives, decompresses, and displays the transmitted raster data. One embodiment of such processing is described below in connection with the embodiment of method 400 shown in FIG. 4.

The embodiment of the remote computing system 100 is shown in FIG. 1 as having a single client device 102 and a single host computer 104. In other embodiments, multiple client devices 102 and/or multiple host computers 104 are used. Moreover, though only a single session 124 is shown on the host computer 104 in FIG. 1, it is to be understood that multiple sessions 124, in other usage scenarios and embodiments, are established on each host computer 104. Furthermore, in the embodiment shown in FIG. 1, remote computing software 133 is executed by the network processor 132 in the client device 102 and remote computing software 162 is executed by network processor 156 in the host computer 104. In other embodiments, remote computing software is executed by a network processor included in a client device that interacts with a host computer but remote computing software is not executed by a network processor (if any) included in the host computer. In other embodiments, remote computing software is executed by a network processor included in a host computer but remote computing software is not executed by a network processor (if any) included in a client device that interacts with the host computer.

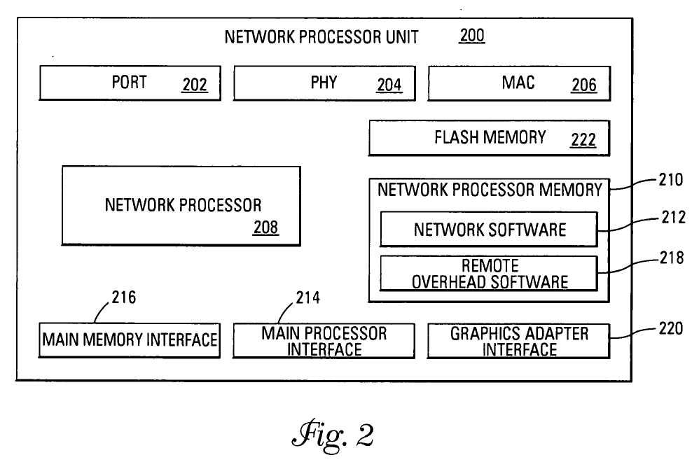

FIG. 2 is a block diagram of one embodiment of a network processor unit 200. The embodiment of network processor unit 200 is suitable for use as the network processor unit 130 of the client device 102 and/or the network processor unit 154 of the host computer 104. The embodiment of network processor unit 200 shown in FIG. 2 is implemented so as to provide ETHERNET networking functions. In other embodiments, the network processor unit (for example, a network processor unit included in a client device and/or a host computer) is implemented in other ways.

In, the embodiment shown in FIG. 2, the network processor unit 200 includes at least one port 202 that provides a point at which a communication medium is physically coupled to the network processor unit 200. In an embodiment where a wireless communication link is used, a communication medium is not necessarily physically coupled to the network processor unit 200 and instead the network processor unit 200 includes an antenna or similar device for receiving and radiating wireless signals over the wireless communication link.

The embodiment of the network processor unit 200 is shown in FIG. 1 as having a single port 202 at which data packets are both received and transmitted. In other embodiments, multiple ports are used, for example, employing transmit and receive ports and/or supporting multiple network connections.

The network processor unit 200 also includes various protocol-specific networking components. For example, in the embodiment shown in FIG. 2, the network processor unit 200 includes a port 202, a physical layer device 204 and a media access control (MAC) device 206. The port 202 provides an interface at which a communication medium (for example, copper twisted-pair wiring) is physically coupled to the network processor unit 200 in order to communicatively couple the network processor to a network. The physical layer device 204 and MAC device 206 provides a physical layer and data layer interface, respectively, to the network to which the network processor unit 200 is coupled. For example where the network protocol unit 200 supports the ETHERNET protocol, the physical layer device 204 is compatible with the communication medium coupled to the port 202 (for example, copper twisted-pair wiring) and the signals traveling over the medium and the MAC device 206 is compatible with the ETHERNET protocol and able to receive and transmit ETHERNET packets.

The network processor unit 200 includes a programmable processor 208 and memory 210 in which software executed by the programmable processor 208 and related data structures are stored during execution. The programmable processor 208 is also referred to here as the “network processor” 208 and the memory 210 is also referred to here as the “network processor memory” 210.

The network processor memory 210 comprises any suitable memory now known or later developed such as, for example, random access memory (RAM), read only memory (ROM), and/or registers within the network processor 208. The software executed by the network processor 208 comprises network software 212 that controls and/or performs networking functions provided by the network processor unit 200. Such networking functions include (but are not limited to) data plane tasks such as a data parsing, classification, data transformation, queuing and scheduling and control plane tasks such as topology management, signaling, network management, and policy applications. Appropriate data structures for implementing such networking functions are stored in the network processor memory 210. Such networking software 210 is typically implemented in a multi-threaded manner. In other embodiments, one or more special purpose devices (for example, application-specific integrated circuits (ASICs), field programmable gate arrays (FPGAs), and additional processors) are used to perform at least some of these data plane and control plane tasks.

The embodiment of the network processor unit 200 shown in FIG. 2 includes a main processor interface 214 and a main memory interface 216. The network processor 208 is able to communicate with the main processor of the device in which the unit 200 is used via the main processor interface 214. Also, the network processor 208 is able to communicate with the main memory of the device in which the unit 200 is used via the main memory interface 216.

For example, where the network processor unit 200 is used in the client device 102, the network processor 208 is able to communicate with the main processor 118 of the client device 102 via the main processor interface 214 and is able to communicate with the main memory 120 via the main memory interface 216. Where the network processor unit 200 is used in the host computer 104, the network processor 208 is able to communicate with the main processor 140 of the host computer 104 via the main processor interface 214 and is able to communicate with the main memory 142 via the main memory interface 216.

In other embodiments, the network processor 208 communicates with the main processor and the main memory of the device into which the unit 200 is used over a single interface (for example, a bus interface) over which the network processor 208 can communicate with both the main processor and the memory.

The software executed by the network processor 208 also comprises remote computing software 218. In general, the remote computing software 218 performs at least some of the remote computing processing (for example, some of the remote computing overhead processing) for the device in which the network processor unit 200 is used.

In one embodiment, the remote computing software 218 processes the raster data of the display image generated by the remote computing software 144 executing on the host computer 104 (for example, as described below in connection with FIGS. 3 and 4 below). In the embodiment shown in FIG. 2, the network processor unit 200 includes a graphics adapter interface 220 via which the network processor 208 is able to communicate directly with a graphics adapter. For example in one implementation, the graphics adapter interface 220 enables the network processor 208 to read raster data from and/or write raster data to a frame buffer included in the graphics adapter. In one implementation, the graphics adapter with which the network processor 208 communicates comprises a Digital Video Interface (DVI) interface and, in such an implementation, the graphics adapter interface 220 comprises a DVI interface suitable for communicating with the graphics adapter over the DVI interface of the graphics adapter. By providing direct access to the graphics adapter, transferring such raster data between the network processor 208 and the frame buffer need not be transferred through the main processor of the device in which the network processor unit 200 is used. Such an approach typically reduces the processing load of the main processor and related interfaces.

In others embodiments, the network processor unit 200 communicates with a graphics adapter in other ways. For example, in one such other embodiment (not shown) the network processor unit 200 does not include a graphics adapter interface 220. In such an embodiment, the network processor unit 200 communicates with the graphics adapter via the main processor of the device in which the network processor unit 200 is used.

The software (including the network software 212 and the remote computing software 218) executed by the network processor 208 comprises appropriate program instructions that implement the functionality to be performed by the software. The program instructions for such software are stored on or in a computer-readable medium. In one embodiment, the computer-readable medium in which the software executed on the network processor 208 is stored comprises flash memory 222. During operation, the network processor 208 reads the program instructions from the flash memory 222 and executes the program instructions.

In other embodiments, the software executed on the network processor 208 is stored on different types of computer-readable media such as a local hard drive, ROM, or removable media such as a floppy drive or a CD-ROM. In other embodiments, the computer-readable media is not local to the device in which the network processor unit 200 is used. For example in one such embodiment, such software is stored on a file server coupled to such device and such software is transferred to the network processor 208 prior to be executed thereby.

FIG. 3 is a flow diagram of one embodiment of a method 300 of processing raster data in a network processor unit. The embodiment of method 300 shown in FIG. 3 is described here as being implemented in the host computer 104 of the remote computing system 100 shown in FIG. 1 using the network processor 200 shown in FIG. 2. In such an embodiment, the embodiment of method 300 is implemented in the remote computing software 162 executing on the network processor 156 of the host computer 104. It is to be understood, however, that other embodiments are implemented in other ways.

Method 300 includes receiving at least a portion of the raster data for a session display image at a network processor unit (block 302). In one embodiment, the session 124 and the software 126 running in the session 124 on the host computer 104 generate a display image (for example, containing a user interface and application-specific content) for that session 124. The session display image is generated by the session 124 and the software 126 using the graphics adapter 148. For example, each item of software 126 executing in the session 124 interacts with a device driver compatible with the graphics adapter 148 to generate portions of the session display image associated with that item of software 126. The session display image, in the embodiment shown in FIG. 1, is generated and stored in the frame buffer 150. In such an embodiment, the remote computing software 162 executing on the network processor 156 receives the at least a portion of the raster data for the session display image from that frame buffer 150. Where the network processor 156 of the host computer 104 is implemented using the embodiment of the network processor unit 200 shown in FIG. 2, the at least a portion of the raster data is received from the frame buffer 150 via the graphics adapter interface 220.

The at least a portion of the raster data for the session display image is compressed by the network processor (block 304). In one embodiment, the remote computing software 162 executing on the network processor 156 compresses the received raster data, for example, using image compression techniques promulgated by the Joint Photographic Experts Group (JPEG). In other embodiments, other compression techniques (for example wavelet-based compression) are used.

The network processor formats the compressed raster data into packets (block 306) and the network processor transmits the formatted packets to a client device (block 308). In one embodiment, the remote computing software 162 executing on the network processor 156 passes the compressed raster data to the network software 160 and other components of the network processor unit 154 executing on the network processor 156 for formatting the compressed raster data into, for example, TCP/IP packets and transmitting over the network 106 in accordance with the ETHERNET protocol. Where the network processor 156 of the host computer 104 is implemented using the embodiment of the network processor unit 200 shown in FIG. 2, the network software 212, MAC device 206, and the physical layer device 204 perform such formatting and transmission of the compressed raster data. The compressed raster data is received at the client device 102 and at least a portion of the received raster data is decompressed and displayed on a display device 112.

FIG. 4 is a block diagram of one embodiment of a method 400 of processing raster data in a network processor unit. The embodiment of method 400 shown in FIG. 4 is described here as being implemented in the client device 102 of the remote computing system 100 shown in FIG. 1 using the network processor 200 shown in FIG. 2. In such an embodiment, the embodiment of method 400 is implemented in the remote computing software 133 executing on the network processor 132 of the client device 102. It is to be understood, however, that other embodiments are implemented in other ways.

Method 400 comprises receiving, at a network processor unit, packets containing compressed raster data for at least a portion of a session display image (block 402) and extracting the compressed raster data from the received packets (block 404). In one embodiment, packets containing compressed raster data are transmitted from the network processor unit 154 of the host computer 104 to the network processor unit 130 of the client device 102 over the network 106. Where the network processor unit 130 of the client device 102 is implemented using the embodiment of the network processor unit 200 shown in FIG. 2, the physical layer device 204, the MAC device 206, and the network software 212 perform the receiving and extracting processing.

The network processor decompresses the extracted compressed raster data (block 406) and outputs the decompressed raster data for the session display image (block 408). In one embodiment, the extracted compressed raster data is provided to the remote computing software 133 executing on the network processor 132 of the client device 104. The remote computing software 133 decompresses the compressed raster data. For example where the compressed raster data was compressed using JPEG compression techniques, the remote computing software 133 uses JPEG decompression techniques to decompress the compressed raster data and outputs the decompressed raster data for storage in the frame buffer 116 of the graphics adapter 114. Where the network processor unit 130 of the client device 102 is implemented using the embodiment of the network processor unit 200 shown in FIG. 2, the remote computing software 218 decompresses the compressed raster data for the session display image and writes the decompressed raster data directly to the frame buffer 116 of the graphics adapter 114 via the graphics adapter interface 220. The graphics adapter 114 uses the raster data stored in the frame buffer 116 to refresh the display image displayed on the output device 112 of the client device 102.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory previously or now known or later developed, including by way of example semiconductor memory devices, such as erasable programmable read-only memory (EPROM), electrically erasable programmable read-only memory (EEPROM), and flash memory devices; magnetic disks such as internal hard disks and removable disks; magneto-optical disks; and DVD disks. Any of the foregoing may be supplemented by, or incorporated in, specially-designed application-specific integrated circuits (ASICs).

What is claimed is:

1. A method comprising:
receiving, at a network processor unit included in a host device, raster data for a remote computing session executing on a main processor of the host device;
compressing the raster data using remote computing software executing on a network processor included in the network processor unit; and
transmitting the compressed raster data to a client device for display thereby.

2. The method of claim 1, wherein the network processor unit provides an interface through which the host device communicates with the client device.

3. The method of claim 1, wherein the network processor processes communications between the host device and the client device.

4. The method of claim 1, further comprising formatting the compressed raster data into packets for transmission.

5. The method of claim 1, wherein compressing the raster data using the remote computing software executing on the network processor includes compressing the raster data using at least one of JPEG compression and wavelet-based compression.

6. The method of claim 1, wherein receiving at the network processor unit comprises receiving the raster data from a graphics adapter included in the host device.

7. The method of claim 6, wherein receiving the raster data from the graphics adapter comprises reading the raster data from a frame buffer included in the graphics adapter included in the host device.

8. The method of claim 1, wherein a display image is generated at the host device for the remote computing session, wherein the display image comprises the raster data.

9. A method comprising:
receiving, at a network processor unit included in a client device, compressed raster data for a remote computing session executing on a host device, wherein the client device comprises a main processor operable to execute first remote computing software operable to affect the remote computing session;
decompressing the received compressed raster data using second remote computing software executing on a network processor included in the network processor unit.

10. The method of claim 9, wherein the network processor unit provides an interface through which the client device communicates with the host device.

11. The method of claim 9, further comprising outputting the decompressed raster data for display on a display device communicatively coupled to the client device.

12. A host computer comprising:
first remote computing software adapted to execute on a main processor of the host computer, the first remote computing software operable to cause the main processor to establish a remote computing session for a client device, wherein a display image comprising raster data is generated for the remote computing session; and
a network interface through which the host computer communicates with the client device, the network interface comprising a network processor adapted to execute second remote computing software, the second remote computing software operable to cause the network processor to compress at least a portion of the raster data;
wherein the network interface transmits the compressed raster data to the client device.

13. The host computer of claim 12, wherein the network interface transmits the compressed raster data to the client device for display thereby.

14. The host computer of claim 12, wherein the network interface receives user input from the client device and forwards the received user input to the first remote computing software executing-on the main processor.

15. The host computer of claim 12, further comprising a graphics adapter, wherein a display image is generated using the graphics adapter.

16. The host computer of claim 15, wherein the graphics adapter comprises a frame buffer in which the raster data is stored, wherein the network processor receives the raster data from the frame buffer.

17. A client device comprising:
first remote computing software adapted to execute on a main processor of the client device, the first remote computing software operable to affect a remote computing session executing on a host computer, wherein the host computer generates a display image comprising raster data for the remote computing session and compresses the raster data; and
a network interface through which the client device communicates with the host computer, the network interface comprising a network processor adapted to execute second remote computing software;
wherein the second remote computing software is operable to cause the network processor to decompress the compressed raster data when the compressed raster data is received by the network interface from the host computer.

18. The client device of claim 17, further comprising a graphics adapter to communicatively couple the client device to a display device, wherein at least a portion of the decompressed raster data is displayed on the display device.

19. A host computer comprising:
first remote computing software adapted to execute on a main processor of the host computer, the first remote computing software operable to establish a remote computing session for a client device; and
a network processor unit that provides an interface through which the host computer communicates with the client device, the network processor unit comprising a network processor adapted to execute second remote computing software that performs at least a portion of remote computing overhead associated with the remote computing session.

20. The host computer of claim 19, wherein the remote computing overhead associated with the remote computing session comprises processing raster data for a display image generated for the remote computing session.

21. A client device comprising:
remote computing software adapted to execute on a main processor of the client device, the remote computing software operable to affect a remote computing session established on a host computer for the client device; and
a network processor unit that provides an interface through which the client device communicates with the host computer, the network processor unit comprises a network processor adapted to execute remote computing software that performs at least a portion of remote computing overhead associated with the remote computing session.

22. The device of claim 21, wherein the remote computing overhead associated with the remote computing session comprises processing raster data for a display image generated for the remote computing session.

23. A host device comprising:
a main processing means on which a remote computing session for a client device is established;
a network interface means through which the host device communicates with the client device, the network interface means comprising a network processing means;
means for receiving, at the network interface means, raster data for the remote computing session;
means for compressing the raster data using remote computing software executing on the network processing means; and
means for transmitting the compressed raster data to the client device for display thereby.

24. A client device comprising:
a main processing means on which remote computing software executes, wherein the remote computing software affects a remote computing session that is established for the client device on a host computer;
a network interface means through which the client device communicates with the host computer, the network interface means comprising a network processing means;
means for receiving, at the network processing means, compressed raster data transmitted from the host computer; and
means for decompressing the received compressed raster data using remote computing software executing on the network processing means.
